(19) United States
(12) Patent Application Publication
(10) Pub. No.: US 2026/0323123 A1
(43) Pub. Date: Oct. 15, 2026

(54) SYSTEM AND METHOD FOR CONTENT DELIVERY TO TARGETED DISPLAY ENDPOINTS WITH DELIVERY VERIFICATION

(71) Applicant: BarBoards LLC, Austin, TX (US)

(72) Inventors: Calvin Wade Giddens, Austin, TX (US); Richard Theriault, Los Gatos, CA (US)

(21) Appl. No.: 19/640,822

(22) Filed: Apr. 7, 2026

Related U.S. Application Data
(60) Provisional application No. 63/785,852, filed on Apr. 9, 2025.

(51) Int. Cl. H04N 21/466; H04N 21/44

(52) U.S. Cl. CPC H04N 21/4668; H04N 21/44008

(57) ABSTRACT

A system and method for targeted content distribution with fingerprint-based delivery verification is disclosed. The content distribution and verification computer receives content from multiple sources including primary and custom content and generates distinctive source fingerprints for both the primary and custom content. Specific custom content is routed to targeted display endpoints based on a routing logic. Routing configuration commands are provided to AV distribution matrix for specific content routing. At the display endpoints, the system captures content samples using sink sampling points and generates corresponding sink fingerprints. A fingerprint matching engine compares sink fingerprints with source fingerprints to compute similarity scores that are quantitative verification of content delivery. When similarity scores fall below predetermined thresholds indicating delivery failure, a dynamic content routing engine automatically reconfigures the AV distribution matrix through content switcher devices to correct routing errors.

### CROSS-REFERENCE TO RELATED APPLICATIONS

This application claims benefit of U.S. Provisional Application No. 63/785,852, filed on 2025 Apr. 9, the disclosure of which is hereby incorporated by reference in its entirety.

### BACKGROUND OF THE INVENTION

### Field of the Art

The disclosure relates to the field of content distribution, and more particularly to the field of verifying the delivery and display of specific content on specific endpoints in complex audio/visual distribution environments.

### Discussion of the State of the Art

Modern audio/visual distribution systems are increasingly complex, particularly in environments such as hotels, sports bars, airports, stadiums, conference centers, retail locations, and other multi-screen venues. These systems typically route numerous content feeds from various sources to multiple display endpoints through intricate distribution networks.

Current video distribution systems typically focus on signal routing rather than content verification. While they may confirm that a signal is being transmitted, they generally cannot verify that specific content within that signal reaches and is displayed on the intended endpoint. The verification performed by existing systems is generally limited to confirming signal presence at the source rather than content delivery at the destination.

Traditional audio/visual routing systems face significant limitations in multi-device environments. They typically operate with a one-to-many broadcast approach where identical content is sent to all connected displays, lacking the capability to target specific content to individual displays. This broadcast-only model fails to address the increasing need for device-specific content delivery.

Some systems also operate as technological “black boxes” with limited visibility into the actual content being routed, making verification virtually impossible. When multiple display endpoints exist, there is no reliable way to confirm which specific content reached which specific device, creating significant challenges for targeted content distribution.

Furthermore, without robust verification mechanisms, there is no systematic way to confirm that the intended content was displayed on the correct endpoint device. This limitation prevents content providers from ensuring that device-specific material reaches its intended destination, making targeted distribution essentially unverifiable in conventional systems.

### SUMMARY OF THE INVENTION

Accordingly, the inventor has conceived and reduced to practice, in a preferred embodiment of the invention, a system and method for targeted content distribution with verification of content delivery through fingerprint-based routing detection and dynamic content switching.

According to a preferred embodiment of the invention, a content distribution and verification system generates source fingerprints from multiple content streams including primary content and custom content, routes specific content to targeted display endpoints through an AV distribution matrix

According to a preferred embodiment of the invention, content delivery verification is achieved by comparing sink fingerprints captured at display endpoints with corresponding source fingerprints using similarity score calculations including Euclidean distance measurements, correlation analysis, and time-domain processing approaches to generate quantitative verification of content delivery.

According to a preferred embodiment of the invention, dynamic routing adjustment is automatically triggered when similarity scores fall below predetermined thresholds, enabling real-time reconfiguration of the AV distribution matrix through content switcher devices to ensure accurate content delivery without manual intervention.

According to a preferred embodiment of the invention, the system maintains continuous verification loops that monitor both primary content and custom content delivery simultaneously, detecting routing configuration changes and automatically adjusts content distribution to maintain proper content associations.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 illustrates an environment including a content distribution and verification computer for targeted content distribution with verification of content delivery, according to an embodiment of the invention.

FIG. 6 is an exemplary flowchart illustrating a method for content preparation and routing, according to an embodiment of the invention.

FIG. 7 is an exemplary flowchart illustrating a method for verification of content delivered to display endpoints, according to an embodiment of the invention.

FIG. 8 is an exemplary flowchart illustrating a method for dynamic routing adjustment based on verification feedback, according to an embodiment of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical, and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of the described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Fingerprint” or “Digital Fingerprint” refers to distinctive digital signature or representation of content data created using mathematical algorithms such that similar content produces similar fingerprints and disparate content produces disparate fingerprints.
“Source fingerprint” refers to fingerprint generated from content data captured upstream of the routing system, near the content sources, used as a reference for verification purposes.
“Sink fingerprint” refers to fingerprint generated from content data captured downstream of the routing system at display endpoints, used for comparison with source fingerprints to verify content delivery.
“Similarity score” refers to numerical value generated by mathematical comparison of fingerprints that indicates the degree of similarity between compared content, typically calculated using methods such as Euclidean distance, correlation analysis, or other mathematical comparison techniques.
“Predetermined threshold” refers to configurable numerical value used as a benchmark for determining successful content delivery, where similarity scores above the threshold indicate delivery success and scores below indicate delivery failure.
“AV distribution matrix” means the hardware and/or software infrastructure that routes audio and video content from sources to multiple display endpoints, including switching devices, network infrastructure, and control systems.
“Content switcher devices” means hardware or software components that implement routing decisions by physically or logically switching content between different distribution paths, including but not limited to HDMI matrix switches, Layer 1 network switches, and IP-based routing software.
“Primary content” means content owned or directly controlled by the system operator, including television programming, streaming content, live feeds, and branded promotional materials.
“Custom content” means content from external providers requiring routing and verification, including advertisements, syndicated programming, user-generated content, and third-party feeds.
“Display endpoint” refers to destination device where content is presented to viewers, including televisions, monitors, digital signage, and other display devices.
“Sink sampling points” refers to measurement locations positioned at or near display endpoints to capture samples of content being displayed for fingerprint generation and verification purposes.
“Source sampling points” refers to measurement locations positioned upstream near content sources to capture samples of content entering the distribution system for reference fingerprint generation.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as, for example, an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

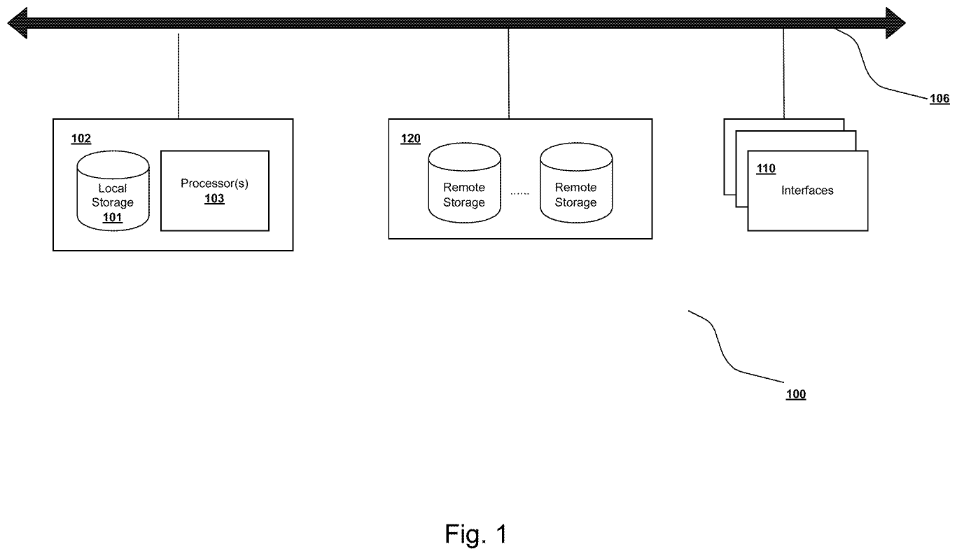

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software-or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid-state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

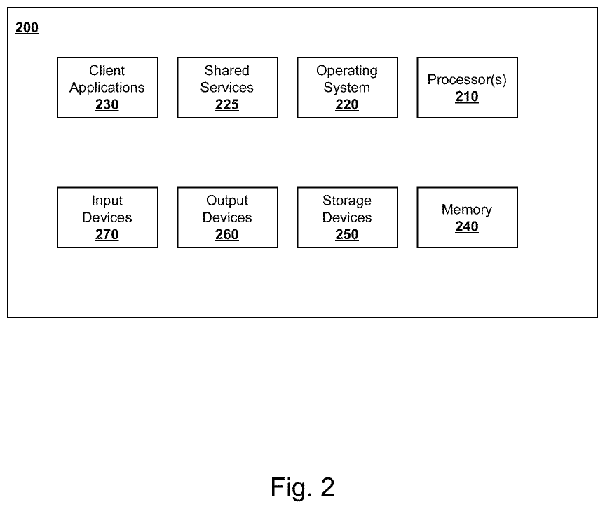

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carries out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

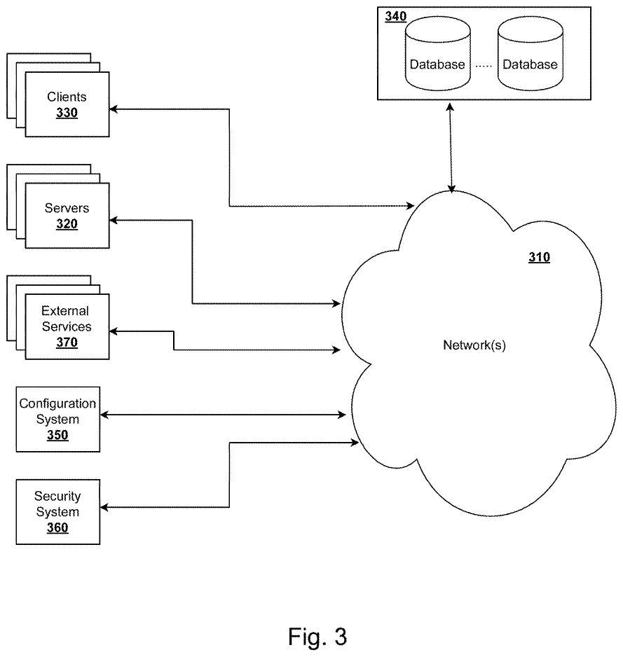

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprises or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google Big Table, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

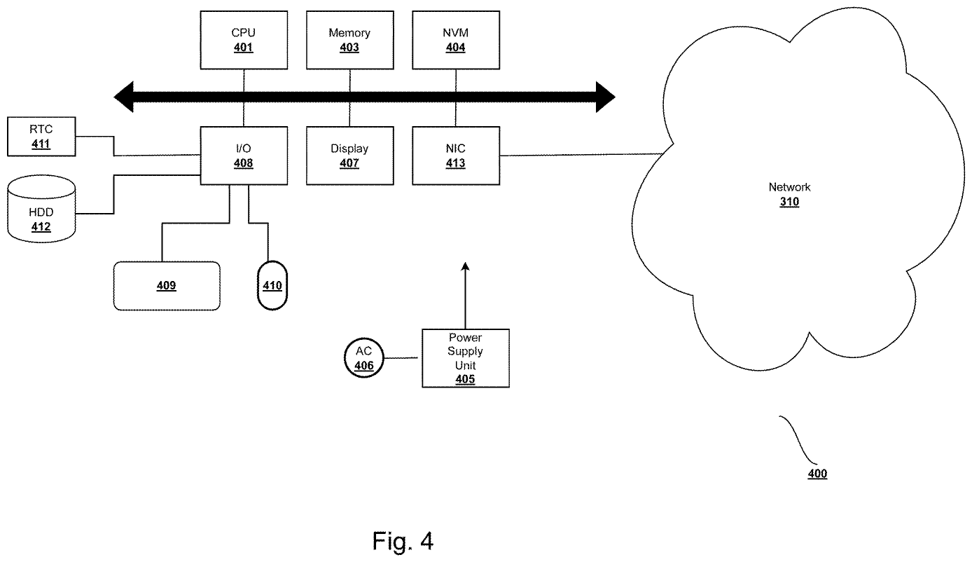

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

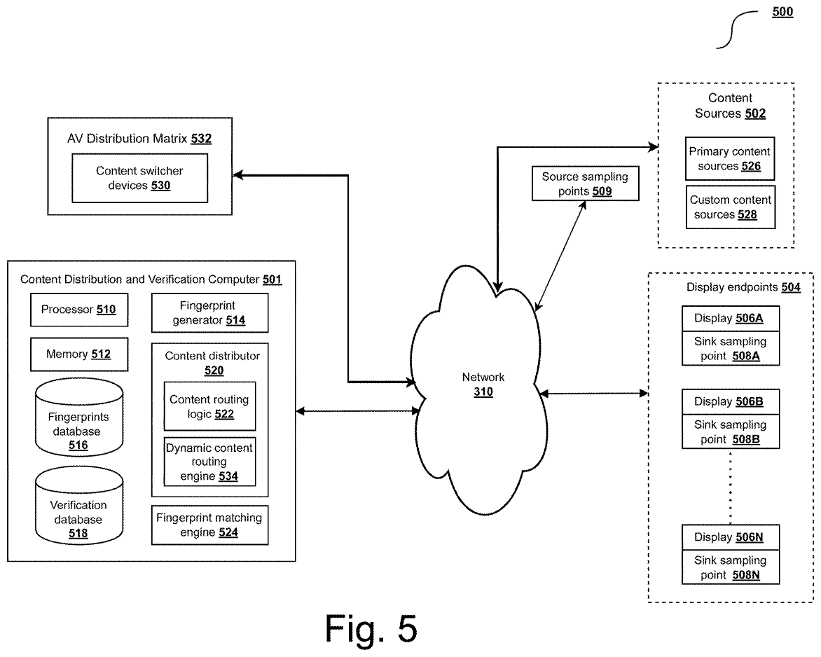

FIG. 5 illustrates an environment 500 including a content distribution and verification computer 501 for targeted content distribution and verification computer 501 for targeted content distribution with verification of content delivery, according to an embodiment of the invention. Components of the system communicate via network 310, including communication between content sources 502, content distribution and verification computer 501, and display endpoints 504.

In an embodiment, all intelligent components including content distribution and verification computer 501, AV distribution matrix 532, source sampling points 509, sink sampling points 508A,508B . . . and 508N, and display endpoints 504 are interconnected via network 310, enabling centralized coordination and verification.

Content distribution and verification computer 501 includes a plurality of components, each comprising at least a plurality of programming instructions, the programming instructions are stored in memory 512 and are executed by one or more processors 510 to perform operations disclosed herein.

In an embodiment, display endpoints 504 may be display devices 506A, 506B . . . 506N (such as TVs, monitors, and digital signage) that present the content to viewers at a location. Examples of locations where multiple devices are present may include but are not limited to, hotels, sports bars, restaurants with multiple TVs, shopping malls, airports, transportation hubs, stadiums, arenas, convention centers, corporate settings, and educational institutions. Each of the display devices 506A, 506B . . . 506N may include respective sampling points 508A, 506B . . . 508N.

In an embodiment, content distribution and verification computer 501 receives content from content sources 502 and transmits contents to be displayed at display devices 506A, 506B . . . 506N using network 310. Content sources 502 represents the various origin points from which content enters the content distribution and verification computer 501. Content sources 502 provide Primary content 526 and custom content 528 to the content distribution and verification computer 501.

Content owned or directly controlled by a primary system operator is referred to as primary content 526. Examples of primary content 526 may include, but is not limited to, primary programming content (sports events, TV shows, movies, etc.), station/network identification segments, interstitial content between programs, branded promotional materials, custom overlay graphics and watermarks, and emergency broadcast information.

Content from external providers that require to be routed and verified may be referred to as custom content 528. Examples of custom content (also referred to as third-party content) 528 may include, but is not limited to advertising from multiple ad networks and agencies, syndicated programming from external studios, live feeds from partner networks, user-generated content from various platforms, sponsored content and product placements, and real-time data feeds (weather, sports scores, stock tickers, etc.).

In an embodiment, signal taps at source sampling points 509 (“upstream”) may capture source signals near content sources 502. The generated source signals may be used for generation of source/reference fingerprints. Measurements components used at source points may include professional-grade signal analysis equipment, hardware taps, or software-based signal capture systems that monitor content streams as they enter the distribution system. Source sampling points 509 positioned upstream of AV distribution matrix 532 and configured to capture content samples from content sources 502 prior to routing, thereby providing reference fingerprints for comparison with downstream fingerprints generated at display endpoints.

In an embodiment, content distribution and verification computer 501 may include fingerprint generator 514, fingerprints database 516, content distributor 520 with content routing logic 522 and dynamic content routing engine 534, verification database 518, and fingerprint matching engine 524. In an embodiment, fingerprint generator 514 may be a software/hardware component that creates identifiers (fingerprints) from content streams for later comparison. Fingerprints are digital signatures that may be created for each piece of content and may be generated based on audio frequency patterns, visual features, or frame sequences. Fingerprint generator 514 processes sampled content (video/audio streams) received from source sampling points 509 and sink sampling points 508A-N to generate source fingerprints and sink fingerprints, in real-time or near-real-time to extract distinctive features. Examples of fingerprints may include, but are not limited to, audio fingerprints, video fingerprints, hash-based fingerprints and cosine-sine decompositions.

In an embodiment, fingerprint generator 514 generates a fingerprint from a sampled content segment by first obtaining a time-bounded audio segment, a frame-bounded video segment, or both, and then extracting a set of representative features from the sampled segment. For audio content, the representative features may include one or more of spectral peaks, band-energy distributions, frequency-domain coefficients, temporal envelope characteristics, or combinations thereof. For video content, the representative features may include one or more of luminance values, color distributions, edge distributions, motion-related features, keyframe-derived features, spatial-frequency coefficients, or combinations thereof. The extracted features may be assembled into a feature vector, reduced in dimensionality if desired, normalized to reduce sensitivity to gain changes, compression artifacts, scaling differences, noise, or transient distortions, and then encoded as a fingerprint record that compactly represents the sampled content segment while preserving similarity relationships among corresponding content samples.

In an embodiment, fingerprint generation is performed on successive content windows such that a stream of temporally ordered fingerprints is produced for each monitored source stream and for each monitored sink stream. By way of example, the content windows may be overlapping or non-overlapping and may correspond to fixed-duration audio intervals, fixed frame counts, detected scene changes, detected keyframes, or other sampling intervals appropriate for the content type. Each generated fingerprint record may be stored together with associated metadata including one or more of timestamp information, source identifier, sink identifier, channel identifier, content identifier, window position, and content type, thereby enabling the system to identify corresponding source fingerprints and sink fingerprints for comparison over matching or candidate-matching intervals. This temporal indexing permits comparison of fingerprints that represent the same underlying content notwithstanding transport delay, buffering delay, transcoding delay, or routing latency within the AV distribution matrix 532.

In an embodiment, fingerprint generator 514 may generate multiple fingerprint representations for the same sampled content segment to improve robustness across heterogeneous delivery environments. For example, a first fingerprint representation may emphasize audio-derived features, a second fingerprint representation may emphasize video-derived features, and a third fingerprint representation may emphasize reduced-dimension composite features derived from both audio and video data. The system may selectively use one representation or multiple representations depending on the content available at a given sampling point and the verification conditions then present. In this manner, the fingerprinting process remains effective where a downstream stream has undergone recompression, scaling, overlay insertion, partial cropping, level adjustment, or other signal modifications that preserve perceptual identity while altering raw signal values.

In an embodiment, cosine-sine decompositions in video/audio streams may be used to generate fingerprints based on their frequency components. In an embodiment, a hash-based fingerprint may be generated. The hash-based fingerprint may be a digital signature or compact representation of a data object (like audio, video, or image) created using hash functions. Unlike traditional cryptographic hashes that completely change with minor input modifications, fingerprinting hash functions are designed so that similar inputs produce similar hash values. In an embodiment, fingerprint database 516 may contain the fingerprint data generated for content by fingerprint generator 514 and the fingerprint data may be used for comparison and verification. In some cases, each piece of content may contain an embedded ultrasonic audio signal that is captured by the small microphone and/or camera. These embedded ultrasonic audio signals may be captured and sent for processing to content distribution and verification computer 501.

Display endpoints 504 comprise multiple display devices 506A, 506B . . . 506N (such as TVs, monitors, and digital signage), each equipped with respective sink sampling points 508A, 508B . . . 508N that capture samples of downstream content. In an embodiment, sink sampling points 508A, 508B . . . 508N may directly sample the video stream being sent to the display. In some cases, sink sampling points (508A, 508B . . . 508N) may be installed in-line with the video signal path, typically between the content distributor and the display device. Sink sampling points 508A, 508B . . . 508N may perform higher quality sampling (no degradation from re-recording), have access to the exact digital values of the video signal, and can capture metadata and other information embedded in the signal. Sink sampling points 508A, 508B . . . 508N may capture frames or segments of the video signal at regular intervals.

In an embodiment, these downstream content samples may be transmitted to content distribution and verification computer 501 that generates sink fingerprints. In another embodiment, sink fingerprints may be generated at the sink sampling points 508A, 508B . . . 508N and transmitted to content distribution and verification computer 501 for fingerprint matching.

Sink sampling points 508A, 508B . . . 508N may be implemented as dedicated hardware devices, software modules within network infrastructure, or hybrid appliances depending on the installation requirements and scale. These verification points may include broadcast-quality signal analyzers, professional AV monitoring equipment, or enterprise-grade verification appliances designed for large-scale audio-visual distribution environments

In some alternate embodiments sink sampling points 508A, 508B . . . 508N may be a small microphone and/or camera attached to or near each display that continuously samples what's being shown on the screen. In some cases, each piece of content may contain an embedded ultrasonic audio signal that is captured by the small microphone and/or camera. These embedded ultrasonic audio signals or image signals may be captured at endpoints and sent for processing to content distribution and verification computer 501. These samples may be processed to generate fingerprints of the currently displayed content.

In an embodiment, during monitoring the source fingerprints (upstream content) are compared with sink fingerprints to determine the current routing configuration through AV distribution matrix 532. This source-to-sink fingerprint mapping enables the system to detect routing path changes and coordinate verification across multiple signal paths simultaneously.

In an embodiment, fingerprint matching engine 524 may compare sink fingerprints with source fingerprints. The comparisons may be performed mathematically and result in a similarity score that is correlated with some similarity metric of the fingerprints. In an embodiment, fingerprint matching engine 524 determines correspondence between a sink fingerprint and one or more candidate source fingerprints by identifying source fingerprint records that fall within a candidate temporal window relative to the timestamp associated with the sink fingerprint. The candidate temporal window may account for transport delay, buffering delay, processing delay, or routing latency within the AV distribution matrix 532. In some embodiments, candidate source fingerprints may be pre-filtered using one or more of content identifiers, channel identifiers, routing expectations, or previously observed mapping relationships to reduce the comparison search space. The fingerprint matching engine 524 may evaluate multiple candidate source fingerprints for a given sink fingerprint and select a best-match candidate based on a computed similarity score.

In an embodiment, the similarity score between a sink fingerprint and a candidate source fingerprint is computed by applying one or more similarity functions to corresponding feature representations. The similarity functions may include distance-based measures, correlation-based measures, or error-based measures applied to feature vectors representing the fingerprints. By way of example, a distance-based measure may compute a Euclidean distance or other norm-based distance between normalized feature vectors, a correlation-based measure may compute a correlation coefficient between time-aligned feature sequences, and an error-based measure may compute a root mean squared error between corresponding feature values. The resulting similarity score may be normalized to a bounded range and may be expressed such that higher similarity scores correspond to higher likelihood that the sink fingerprint and the source fingerprint represent the same underlying content.

In an embodiment, fingerprint matching engine 524 evaluates similarity over a sequence of temporally adjacent fingerprints rather than relying on a single comparison instance. Similarity scores may be aggregated across multiple time windows using one or more aggregation functions including averaging, weighted averaging, rolling window analysis, or persistence-based evaluation. This temporal aggregation reduces sensitivity to transient noise, partial occlusion, signal degradation, or brief content transitions. For example, a transient mismatch occurring within a single sampling window may be disregarded if similarity scores in adjacent windows remain above a threshold, whereas sustained mismatches across multiple consecutive windows may be interpreted as a routing change or content delivery failure.

In an embodiment, fingerprint matching engine 524 determines whether a sink fingerprint corresponds to a source fingerprint by comparing an aggregated similarity score to a predetermined threshold. The predetermined threshold may be fixed, configurable, or dynamically adjusted based on one or more of content type, signal quality, historical match confidence, or environmental conditions. A match condition may be declared when the aggregated similarity score exceeds the predetermined threshold for a required persistence duration, and a mismatch condition may be declared when the aggregated similarity score remains below the predetermined threshold for the required persistence duration. In some embodiments, multiple thresholds may be used, including a high-confidence threshold for definitive matching and a lower-confidence threshold for candidate matching subject to further evaluation.

For example, a similarity score may be computed as a Euclidean distance between vector representations of the coefficients of cosine-sine decompositions of two images or audio segments. Closer vectors have similar frequency components and result in a lower distance measurement indicative of a higher similarity between the content. For time-domain or changing signals, it may be appropriate to measure similarity scores over time to reduce uncertainty and/or noise as the signals and fingerprints evolve. Example time-domain processing approaches: Correlation, Root Mean Squared Error (RMSE), and fuzzy logic. Example use-case: for routing configurations that rarely change, a sudden drop in match confidence is more likely to be noise than an actual routing change.

A routing configuration change is detected when the intended custom content was not displayed at the targeted display endpoints 504. In an embodiment, dynamic content routing engine 534 determines a routing state for each display endpoint based on the output of fingerprint matching engine 524 by classifying the comparison result as a match condition, a mismatch condition, or an indeterminate condition. The classification may be based on the aggregated similarity score, the persistence duration associated with the similarity score, and one or more contextual parameters including expected routing configuration, content schedule, or previously observed mapping relationships. A match condition indicates that the current routing configuration for the display endpoint is consistent with an intended content mapping, a mismatch condition indicates that the current routing configuration deviates from the intended content mapping, and an indeterminate condition indicates insufficient confidence to declare either a match or mismatch. Dynamic content routing engine 534 operates in conjunction with content routing logic 522, wherein content routing logic 522 determines intended routing of content and dynamic content routing engine 534 modifies routing configuration responsive to verification results produced by fingerprint matching engine 524.

In an embodiment, responsive to a mismatch condition, dynamic content routing engine 534 identifies an intended source content and an observed source content for the affected display endpoint by evaluating candidate source fingerprints that correspond to the sink fingerprint. The intended source content may be determined from a routing table, content schedule, or previously established mapping, while the observed source content may be determined from the best-matching candidate source fingerprint identified by fingerprint matching engine 524. By comparing the intended source content and the observed source content, the system determines whether the mismatch is attributable to a primary content change, an incorrect custom content insertion, or a routing path inconsistency within the AV distribution matrix 532.

In an embodiment, dynamic content routing engine 534 generates a routing update instruction responsive to the mismatch condition by selecting a corrected routing configuration that maps the intended source content to the affected display endpoint. The routing update instruction may specify one or more of a source identifier, a destination display endpoint identifier, a switching path, or a content channel to be applied by one or more content switcher devices. In some embodiments, the routing update instruction may be derived from a routing table lookup, a rule-based evaluation, or a constraint-based selection that considers content type, display location, priority level, or contextual factors including time of day or occupancy.

In an embodiment, execution of the routing update instruction is conditioned on a persistence requirement associated with the mismatch condition to prevent oscillatory behavior or unnecessary switching. The persistence requirement may specify that the mismatch condition must be maintained for a minimum duration or across a minimum number of consecutive fingerprint comparisons before a routing update is executed. Additionally, routing updates may be rate-limited or prioritized across multiple display endpoints to prevent excessive simultaneous reconfiguration of the AV distribution matrix 532. Upon execution of the routing update instruction, the system resumes fingerprint-based verification to confirm that the updated routing configuration satisfies the intended content mapping.

Fingerprint matching engine 524 may compare the generated fingerprints with corresponding source fingerprints to generate similarity scores. These similarity scores indicate whether intended content was successfully delivered to the targeted display endpoint.

In an embodiment, the system addresses various edge cases and transitional scenarios that occur during normal operation. During content transitions, such as when a display switches from one program to another or when a commercial break begins or ends, fingerprint matching engine 524 may temporarily suspend strict verification for a configurable transition period, typically 2-5 seconds. This transition period allows the routing changes to propagate through the AV distribution matrix 532 and for the new content to stabilize at display endpoints 504 before resuming verification.

To avoid reacting to transient anomalies, dynamic content routing engine 534 may implement a persistence requirement for routing corrections. Routing corrections are triggered only when similarity scores remain consistently below the predetermined threshold for a configurable persistence period, typically 15-60 seconds depending on the criticality of the content and venue requirements. This persistence requirement prevents the system from unnecessarily switching content in response to brief, self-correcting issues.

In scenarios where multiple displays simultaneously experience verification failures, the system prioritizes routing corrections based on content criticality and display importance. For example, displays in high-traffic areas or those showing high-value advertising content may be prioritized for immediate correction, while displays in secondary locations may be queued for correction with slight delay. The system maintains a correction queue managed by the dynamic content routing engine 534, processing corrections in priority order while avoiding overwhelming the AV distribution matrix 532 with simultaneous reconfiguration commands.

In an embodiment, AV distribution matrix 532 configuration may be automatically adjusted based on change in routing configuration. Any change in routing configuration may result in the update of AV distribution matrix 532 and switching is performed based on the updated matrix in the AV distribution matrix configuration, wherein the AV distribution matrix 532 uses content switcher devices 530 to implement routing configuration changes. Content switcher devices 530 may include hardware/software components that physically or virtually switch content between different routing paths. In digital (IP-based) systems, where data feeds are packet streams, content can be routed to different display endpoints 504 using software. In some cases, Layer 1 network switches and HDMI matrix switches may be used to switch between multiple video inputs.

During operation, a continuous verification feedback loop is implemented where source fingerprints and sink fingerprints are processed by fingerprint matching engine 524 to identify routing changes. Dynamic content routing engine 534 may provide adjustments to routing configuration, creating a self-correcting content distribution system that ensures accurate content delivery without manual intervention.

In an embodiment, AV distribution matrix 532 serves as the central switching infrastructure that routes content from content sources 502 to targeted display endpoints 504.

In an embodiment, AV distribution matrix 532 may include content switcher devices 530 that implement the physical or logical switching decisions determined by dynamic content routing engine 534 based on changes in the AV distribution matrix configuration. The routing configuration may be maintained by AV distribution matrix 532.

In an embodiment, dynamic content routing engine 534 may maintain centralized control over AV distribution matrix 532 through network-based communication, enabling dynamic reconfiguration of content switcher devices 530 based on changes in routing configuration. The matrix configuration data is stored and managed within the computer's memory 512 and databases.

In an embodiment, the dynamic content routing engine 534 serves as an integrated component within content distribution and verification computer 501, providing intelligent routing decisions based on real-time verification feedback from display endpoint 504. Dynamic content routing engine 534 coordinates with content routing logic 522 to implement both content selection decisions (what content goes where) and infrastructure routing decisions (how content flows through the distribution matrix), creating a unified verification-driven routing system.

The system supports scalable verification architecture ranging from small installations with minimal verification points to large enterprise systems with extensive distributed verification infrastructure suitable for venues including hotels, sports facilities, airports, stadiums, and corporate facilities.

In an embodiment, content distributor 520 may be a central software platform that manages the scheduling and distribution of content. A dynamic content routing engine 534 uses the content routing logic 522 to determine which custom content should be routed to which specific display endpoints. Content distributor 520 may be implemented as a software component executing within content distribution and verification computer 501 and configured to manage routing of content through AV distribution matrix 532.

In an embodiment, dynamic content routing engine 534 may switch the custom content to be delivered to a specific set of display endpoints 504 based on the change routing configuration due to a mismatch between sink and source fingerprints. The custom content may be associated with a primary content being streamed at the content display. Changes in the primary content (example, TV channel) may require a change in the custom source 502 for the targeted display endpoint. For example, dynamic content routing engine 534 may initiate changes in the routing of custom content to specific displays based on changes in the primary content being transmitted at the targeted display endpoint.

In an embodiment, a custom content being routed to targeted display endpoints may be changed based on a change in the primary content. Further, the custom content being routed to targeted display endpoints may be changed based on current occupancy, day of week, time of day, and events.

In an embodiment, routing configuration change is detected when inputs from users result in change of the primary content (TV channel) at display endpoints 504. The user can manually configure or override routing.

During operation, content routing logic 522 may be used by content distributor 520 to evaluate incoming content streams and make decisions about where each content should be routed. These decisions may be communicated to the content distributor 520. Content distributor 520 implements these decisions through content switcher devices 530 and content travels through the network 310 to reach targeted display endpoints 504. During periodic programming breaks, content distribution and verification computer 501 may switch or overlay the main content with content for targeted display.

In an embodiment, content distributor 520 may simultaneous route different custom content 528 streams to different display endpoints 504 concurrently based on decisions made by content routing logic 522. For example, during a multi-sport viewing event, the system may simultaneously route beer advertisements to displays showing NFL football, luxury car promotions to displays showing PGA golf, energy drink advertisements to displays showing NBA basketball, and automotive parts promotions to displays showing NASCAR racing, all while maintaining synchronized delivery timing across different sports programming. This simultaneous routing capability maximizes advertising effectiveness by ensuring each sport's audience receives the most relevant custom content for their specific viewing preferences and demographic profile. This parallel content distribution capability enables venue operators to maximize advertising revenue by delivering precisely targeted custom content that aligns with each sport's typical audience demographics and interests.

In an embodiment, content distribution and verification computer 501 may implement a multi-channel architecture supporting simultaneous routing of different content streams to simultaneously route different content streams to different displays. Content distributor 520 may maintain separate routing channels for each unique content stream, with each channel managed by a dedicated processing thread or process. The dynamic content routing engine 534 coordinates timing across multiple content switcher devices 530 using timestamp synchronization protocols to ensure that custom content insertion occurs at appropriate moments relative to primary content delivery.

In an embodiment, content distribution and verification computer 501 may allocate network bandwidth proportionally based on the number of active streams and display endpoints, with typical bandwidth allocation of 10-50 Mbps per HD video stream. Processing resources are scaled using load balancing algorithms that distribute fingerprint generation and matching operations across multiple processor cores in processor 510.

In an embodiment, content distribution and verification computer 501 may detect triggers to determine the precise moments when content targeted for specific displays should be inserted or overlayed. Content distribution and verification computer 501 actively monitors content being displayed at display endpoints 504 and determines when to switch or overlay the main content (primary content). In some cases, the trigger may be inserted by the content sources 502 in the content. In an example, content distribution and verification computer 501 may detect that it's time for an ad break and perform a content switch using content switcher devices 530.

The architecture shown in FIG. 5 is designed for scalability across a wide range of deployment sizes, from small installations to large enterprise systems. The system scales effectively from minimal configurations supporting three to five display endpoints to large-scale deployments supporting hundreds of display endpoints through architectural adaptations and distributed processing strategies. For small to medium installations with up to approximately fifty display endpoints 504, a single content distribution and verification computer 501 provides adequate processing capacity.

In this configuration, processor 510 typically comprises a multi-core system with 4-16 cores, and memory 512 typically comprises sixteen to sixty-four GB of RAM. Fingerprint generator 514 and fingerprint matching engine 524 distribute processing across available cores, with each core handling fingerprint operations for a subset of display endpoints. Network bandwidth requirements in this configuration typically range from 100 Mbps to 1 Gbps depending on content resolution (standard definition vs. high definition) and the number of concurrent content streams. For medium to large installations with fifty to two-hundred display endpoints, the system employs a distributed processing architecture. Multiple content distribution and verification computers 501 may be deployed in a clustered configuration, with each node responsible for a subset of display endpoints. A master coordination node manages cluster membership and distributes display endpoint assignments among worker nodes. This distributed architecture enables horizontal scaling and additional processing capacity can be added by introducing additional nodes to the cluster without disrupting ongoing operations

For very large installations such as stadiums, airports, or convention centers with more than two hundred display endpoints, the system employs hierarchical distribution architecture. Edge processing nodes are deployed in proximity to groups of display endpoints, with each edge node handling local fingerprint generation and matching for twenty to fifty nearby displays. Edge nodes perform initial verification locally and report verification results to regional aggregation nodes, which in turn report to central coordination servers. This hierarchical architecture minimizes network bandwidth requirements by processing verification locally and transmitting only compact verification results rather than full content samples across the network. Network bandwidth requirements scale approximately linearly with the number of active content streams and display endpoints.

The system automatically discovers new display endpoints through network scanning or manual registration, initializes appropriate sink sampling points, and begins verification operations without service interruption to existing displays. Database scalability is achieved through appropriate technology selection and architecture. Fingerprints database 516 and verification database 518 may employ database clustering, sharding, or replication strategies to support high transaction volumes and large data sets.

FIG. 5 illustrates a closed-loop content verification and routing control system in which fingerprint matching results produced by fingerprint matching engine 524 are used by dynamic content routing engine 534 to update routing through AV distribution matrix 532.

### Detailed Description of Exemplary Embodiments

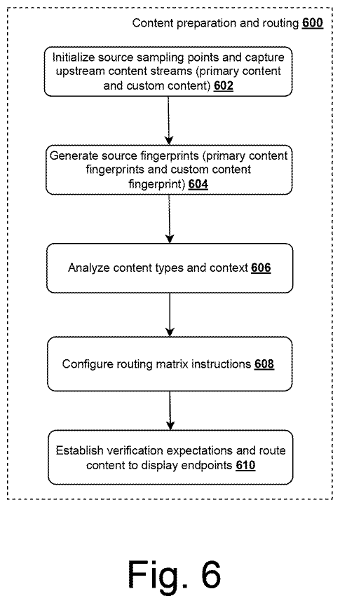

FIG. 6 is an exemplary flowchart illustrating a method 600 for content preparation and routing, according to an embodiment of the invention.

The steps of method 600 may be performed by content distribution and verification computer 501. Processor 510 may execute instructions stored in memory 512 to generate fingerprints, implement content routing decisions, and verify delivery of content to targeted display using fingerprinting matching algorithms.

Content sources 502 provide primary content 526 (sports events, TV shows, movies, station identification segments) and custom content 528 (advertising from multiple ad networks, syndicated programming, live feeds from partner networks, user-generated content, sponsored content and product placements). Content may content distribution and verification Computer 501 through various data feeds including digital video (HDMI, TCP/IP), analog video (component), digital audio (S/PDIF, TOSLINK, PCM), analog audio (RCA, 3.5 mm, phono), and RF (QAM)

At step 602, content distribution and verification computer 501 may initialize source sampling points 509 and captures upstream content streams (primary content and custom content). Source sampling points 509 may be near content sources 502. Signal taps are inserted upstream of the routing system to determine the routing configuration Source sampling points 509 use professional-grade signal analysis equipment, hardware taps, or software-based signal capture systems. Source sampling points 509 captures upstream content streams from both primary content 526 and custom content 528. Source sampling points 509 monitor all incoming content feeds in real-time or near-real-time as they enter the distribution system. Data streams upstream of the routing system are called “sources” for fingerprinting purposes.

At step 604, fingerprint generator 514 may generate reference/source fingerprints from received content streams by extracting distinctive features Fingerprint generator 514 may process content from various sources including first-party content 526 and third-party content 528 to create digital signatures (fingerprints) based on audio frequency patterns, visual features, or frame sequences. The fingerprint may be a hash-based fingerprint designed so that similar inputs produce similar hash values. In some embodiments, cosine-sine decompositions may be used to generate fingerprints based on frequency components. These source fingerprints are stored as reference/upstream fingerprints in fingerprints database 516 and used later during and verification process. Source fingerprints are stored as reference fingerprints in fingerprints database 516 along with content metadata, routing intentions, and content specifications Fingerprint data is used for comparison and verification throughout the distribution system

At step 606, content distributor 520 may use content routing logic 522 to evaluate incoming content streams and make routing decisions based on multiple factors including time, location, audience characteristics, current occupancy, day of week, time of day, and events. Content distributor 520 may determine target displays based on content type and contextual requirements. For example, in an airport terminal, primary content 526 may show flight departure information, and custom content 528 routes duty-free shopping promotions and last-minute travel insurance offers.

For example, in a sports bar environment, content routing logic 522 may determine that endpoint displays showing NFL football should receive beer and wing advertisements, while endpoint displays showing PGA golf should receive luxury car and financial services promotions, and endpoint displays showing NBA basketball should receive energy drink and athletic wear advertisements.

At step 608, routing matrix instructions are configured. Routing matrix configuration commands may be generated for AV distribution matrix 532 based on content analysis and contextual logic. Content switcher devices 530 with specific routing paths direct identified content types to appropriate display endpoints 504. In an embodiment, routing tables may be created that map content fingerprints to target display endpoints.

In an example, during simultaneous multi-sport broadcasting, the routing matrix may be configured to deliver sport-specific custom content based on the primary sports being streamed at a display endpoint. Different primary sports content may be streamed at different display zones and different sport-specific custom content may route based on the primary sport. For example, NFL football with beer advertisements to main bar displays (5 displays), PGA golf with luxury automobile promotions to VIP lounge displays (4 displays), NBA basketball with energy drink advertisements to casual dining displays (4 displays).

Consider another example of a venue with 15 displays showing 3 different sports (NFL football on five displays, PGA golf on four displays, NBA basketball on six displays. The system may maintain three primary content streams and three corresponding custom content streams. AV distribution matrix 532 uses time-division multiplexing or frequency-division multiplexing techniques to transmit multiple streams concurrently through network 310. Each content switcher device 530 is configured with routing tables that specify which content channels to decode and forward to specific display endpoints 504.

At step 610, verification expectations are established and content is routed to the targeted display endpoint. Set up verification parameters in the system defining what content should appear at which display endpoints 504. The expected fingerprint matches between source fingerprints and anticipated sink fingerprints for each display is configured. This preparation sets a baseline expectation for successful content delivery confirmation.

During operation, fingerprint generator 514 may simultaneously process multiple content streams from diverse sources including primary content 526 and custom content 528, creating comprehensive fingerprint libraries that support complex multi-display environments without performance degradation. stored fingerprints in fingerprints database 516 creates a reusable content identification system that enables quick recognition of recurring programming and advertisements, reducing processing overhead for repeated content. Further, as the system links custom content 528 fingerprints with appropriate primary content 526 contexts, automatic content matching is enabled that ensures beer advertisements appear during sports programming.

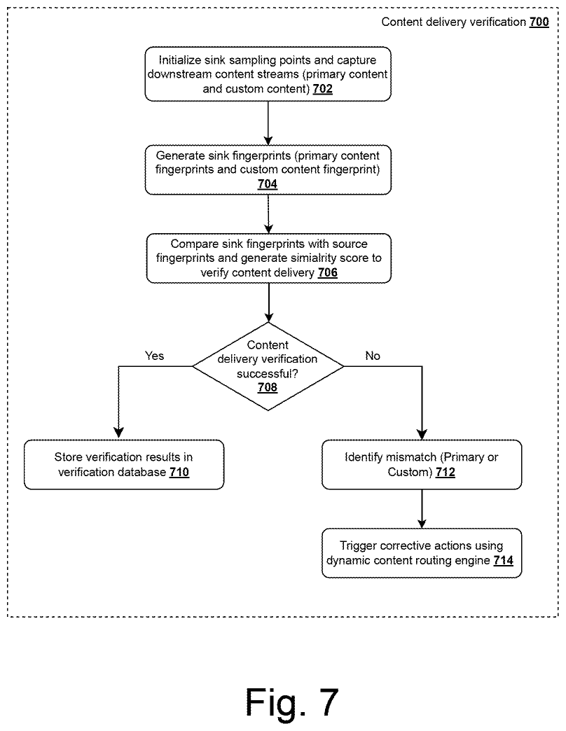

FIG. 7 is an exemplary flowchart illustrating method 700 for verification of content delivered to display endpoints 504, according to an embodiment of the invention.

At step 702, the verification system may be initialized by activating sink sampling points 508A, 508B . . . 508N at display endpoints 504 and content samples are captured from content streams displayed at display endpoint 504. Each display device 506A, 506B . . . 506N includes a respective sampling point that communicated with content distribution and verification computer 501. Sink sampling points 508A-N capture samples from content streams of both primary content 526 and custom content 528 being displayed. Content samples are captured at regular intervals during active streaming on display devices 506A-N. Data streams downstream of the routing system are called “sinks” for fingerprinting comparison.

At step 704, content distribution and verification computer 501 may perform centralized fingerprint generation from content samples collected by sink sampling points 508A, 508B . . . 508N. Fingerprint generator 514 may process all collected content samples to create fingerprints using consistent algorithms and parameters, ensuring accurate comparison with source fingerprints. Sink sampling points 508A, 508B . . . 508N may capture audio snippets, video frames, or other content elements at regular intervals, creating content sample data that represents the actual content delivered to each specific display endpoint. Sink fingerprints are generated for both primary content 526 and custom content 528. Sink fingerprints may be generated based on audio frequency patterns, visual features, or frame sequences from the displayed content.

At step 706, fingerprint matching engine 524 may compare the sink fingerprints with the source fingerprints. If sink fingerprints match source fingerprints, routing configuration confirms matching source is routed to matching sink. These comparisons are performed mathematically and result in a similarity score that indicates whether the displayed content was intended for that specific display. The system generates similarity scores using mathematical comparison methods including Euclidean distance calculations, frequency component analysis, and time-domain processing approaches.

Fingerprint matching engine 524 may compare the sink fingerprints with corresponding source fingerprints to generate similarity scores. These similarity scores indicate whether intended content was successfully delivered to the targeted display endpoint. A higher similarity score represents a closer fingerprint match and indicates that content delivery verification was successful. A lower similarity scores represents a poor fingerprint match and indicates that content delivery verification was unsuccessful. A predetermined threshold may be used to determine if the content delivery verification based on the similarity score. In some cases, if there is partial match, the fingerprints may be flagged for manual review.

In an example, source fingerprint vector [0.82, 0.45, 0.91, 0.67, 0.73] is compared with sink fingerprint [0.83, 0.44, 0.90, 0.68, 0.72], yielding a Euclidean distance of 0.024, which translates to similarity score of 0.976, exceeding the predetermined threshold of 0.90, indicating successful content delivery.

In an embodiment, fingerprint matching engine 524 may employs an adaptive threshold determination mechanism that accounts for content type, environmental conditions, and historical performance metrics. A baseline threshold may be established based on initial similarity thresholds using statistical analysis of fingerprint distribution.

In an embodiment, a predetermined threshold for similarity scores may be typically set between 0.80 and 0.95, depending on content type and quality requirements. For high-confidence verification of advertising delivery where billing accuracy is critical, a threshold of 0.90 or higher may be used. For less critical content verification, a threshold of 0.80-0.85 may be acceptable. The threshold may be dynamically adjusted based on historical match confidence data and environmental factors such as signal quality. In one embodiment, the system maintains separate thresholds for audio fingerprints (typically 0.85-0.92) and video fingerprints (typically 0.88-0.95), with video fingerprints generally requiring higher thresholds due to greater complexity.

At step 708, system may determine whether the content delivery verification was successful. In case of successful content delivery verification, content distribution and verification computer 501, at step 710, stores the verification results are stored in the verification database 518. The system generates verification certificates containing similarity scores, confidence intervals, timestamp data, and content identification metadata that provide legally defensible proof of content delivery for billing and compliance purposes. The verification process provides an immediate confirmation that both primary content 526 and custom content 528 are correctly displayed at targeted display endpoints 504, eliminating guesswork and ensuring viewers receive the intended content experience without manual monitoring requirements.

Verification results help advertisers receive mathematical proof that their custom content 528 has reached the correct display endpoints 504 during the intended primary content 526 programming, enabling accurate billing and performance reporting for targeted advertising campaigns. The mathematical proof of content delivery comprises multiple verification layers including statistical confidence calculations, temporal consistency analysis across multiple measurement intervals, and cross-validation between multiple sampling points when available.

In case the content delivery verification is not successful, system may, at step 712, identify if the mismatch between the source and sink fingerprints is for the primary content 526 or custom content 528. Once the content source mismatch is identified, then at step 714, corrective actions are triggered at content distribution and verification computer 501 using dynamic content routing engine 534. As fingerprint matching engine 524 continuously compares source and sink fingerprints, and automatically identifies when wrong content reaches specific displays within seconds, prolonged delivery of inappropriate advertisements or programming to unintended audiences is prevented.

For example, if instead of an energy drink custom content intended for display 506B showing NBA basketball (primary content) a luxury car advertisement (incorrect custom content) meant for the PGA golf is displayed, the similarity score between the sink fingerprint and the intended source fingerprint would fall below the predetermined threshold, indicating delivery failure. The system would detect that the basketball audience received golf-targeted content, triggering corrective action.

The fingerprint-based verification process in method 700 operates without interrupting content flow or requiring viewer interaction, maintaining seamless entertainment experiences while providing robust delivery confirmation.

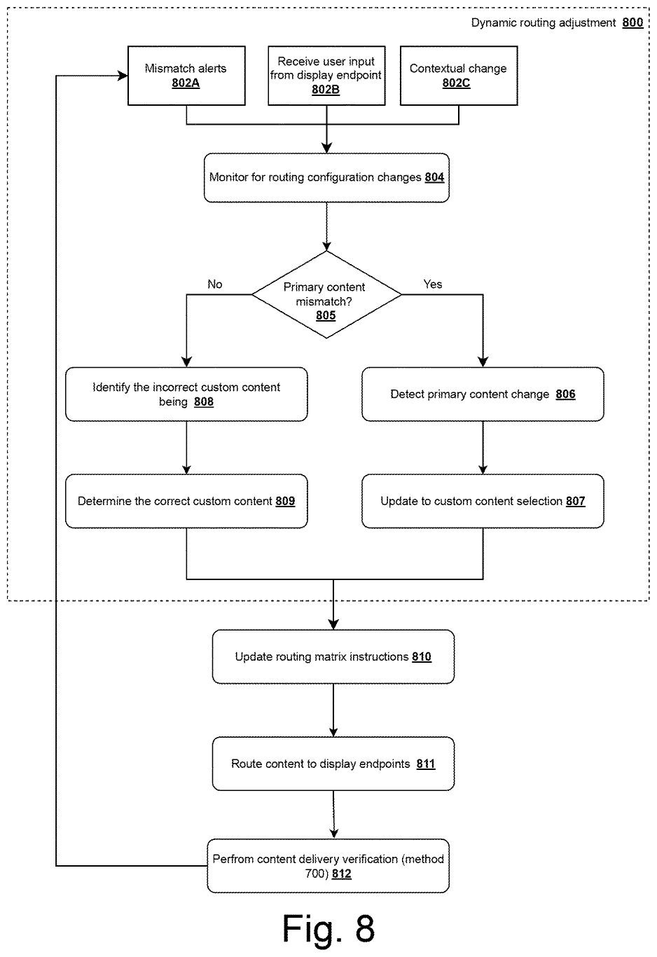

FIG. 8 is an exemplary flowchart illustrating a method 800 for dynamic routing adjustment based on verification feedback, according to an embodiment of the invention.

At step 804, dynamic content routing engine 534 may monitor for routing configuration change triggers. The routing configuration may be changed due to several factors including, but not limited to mismatch alerts 802A due content delivery verification failure, user inputs from display endpoints 802B, and contextual changes 802C.

Dynamic content routing engine 534 may be configured to detect inputs (manual routing configuration changes or override commands) from users resulting in change of primary content (TV channel changes) at display endpoints 504. Contextual changes 802C may include factors including, but not limited to, changes in current occupancy, day of week, time of day, and events that require routing adjustments.

At step 805, dynamic content routing engine 534 determines whether the mismatch in fingerprints is found in the primary content 526. Primary content mismatch happens when users change TV channels, requiring different custom content 528.

At step 806, dynamic content routing engine 534 may identify the change in the primary content 526 and at step 807, updates the custom content selection based on the changed primary content 526. For example, when a user changes the primary content from an NFL football game to a NASCAR race on display endpoint 506B, the system automatically switches the associated custom content from beer and wings advertisements to automotive parts and motor oil promotions, maintaining appropriate sport-audience content alignment.

At step 805, when dynamic content routing engine 534 determines that the mismatch in fingerprints is not present in the primary content 526, then at step 808, dynamic content routing engine 534 may determine the incorrect custom content. The incorrect custom content is a content that is not associated with the primary content being played at the targeted display endpoint 504.

After identifying the incorrect custom content, dynamic content routing engine 534, at step 809 may determine the correct custom content associated with the targeted display endpoint. Content routing logic 522 may be applied to determine proper content to display association.

At step 810, dynamic content routing engine 534 may provide instructions to reconfigure the AV distribution matrix configuration. Dynamic content routing engine 534 may maintain centralized control over AV distribution matrix 532 through network-based communication, enabling dynamic reconfiguration of content switcher devices 530 based on changes in routing configuration. Routing matrix configuration commands may be generated for AV distribution matrix 532 based on content analysis and contextual logic.

At step 811, routing decisions updated in AV distribution matrix configuration are implemented by directing specific content to specific endpoints. Dynamic content routing engine 534 immediately responds to verification mismatches by reconfiguring the AV distribution matrix 532, correcting content delivery errors without requiring manual intervention or service interruption. Routing changes occur transparently in the background through content switcher devices 530, ensuring that viewers experience smooth content transitions without blackouts, interruptions, or visible switching delays.

The system supports heterogeneous switching environments combining hardware-based switching for high-bandwidth primary content with software-based switching for lower-bandwidth custom content insertion. Layer 1 network switches provide nanosecond-level switching capabilities for real-time content routing, while HDMI matrix switches enable direct digital video routing with embedded audio channels. IP-based software switching utilizes packet-level routing tables and Quality of Service (QoS) management to ensure reliable content delivery across network infrastructure.

At step 812, content delivery verification is performed using method 700. The verification process in method 700 is reactivated to compares source vs sink fingerprints for both content types. New similarity scores are generated to validate successful routing adjustments.

This comprehensive verification system ensures that both primary content 526 and custom content 528 reach their intended display endpoints 504 through continuous fingerprint matching and dynamic routing adjustments via AV distribution matrix 532.

Content routing logic 522 may continuously learn from successful routing corrections, improving future decision-making and reducing the frequency of mismatches through predictive content association. As the system addresses both primary content 526 and custom content 528 routing issues simultaneously, display content may be changed to maintain appropriate content relationships and advertising effectiveness.

The skilled person will be aware of a range of possible modifications of the various embodiments described above. Accordingly, the present invention is defined by the claims and their equivalents.

What is claimed is:

1. A system for content distribution and verification, the system comprising:
a content distribution and verification computer comprising a processor, a memory, and a plurality of programming instructions, the plurality of programming instructions when executed by the processor cause the processor to:
generate source fingerprints from content streams, wherein each source fingerprint represents distinctive features of content including primary content and custom content;
receive captured content samples from a plurality of sink sampling points positioned at a plurality of display endpoints;
generate sink fingerprints from the captured content samples;
identify one or more candidate source fingerprints corresponding to each sink fingerprint based on temporal association of the captured content samples;
compute a similarity score between each sink fingerprint and at least one candidate source fingerprint using a similarity function applied to feature representations of the fingerprints;
determine a content delivery state for each display endpoint based on the similarity score and a predetermined threshold, wherein the content delivery state comprises at least one of a match condition or a mismatch condition; and
store verification results including the determined content delivery state for the plurality of display endpoints.

2. The system of claim 1, wherein the processor is further configured to compute the similarity score based on a plurality of temporally adjacent sink fingerprints and corresponding candidate source fingerprints.

3. The system of claim 2, wherein the similarity score is computed by aggregating similarity values across the plurality of temporally adjacent fingerprints using at least one aggregation function.

4. The system of claim 1, wherein the processor is further configured to determine the mismatch condition when the similarity score remains below the predetermined threshold for a persistence duration.

5. The system of claim 1, wherein the predetermined threshold comprises a plurality of thresholds including at least a first threshold corresponding to a match condition and a second threshold corresponding to a candidate match condition.

6. The system of claim 1, wherein the processor is further configured to generate a routing update instruction responsive to the mismatch condition.

7. The system of claim 6, wherein the routing update instruction is generated based on a comparison between intended content associated with a display endpoint and observed content identified from the candidate source fingerprint.

8. The system of claim 1, wherein the custom content comprises advertisement content, and wherein the processor is further configured to verify delivery of the advertisement content to targeted display endpoints using the determined content delivery state.

9. The system of claim 1, wherein the processor is further configured to simultaneously route different primary content and corresponding different custom content to different display endpoints, and to determine respective content delivery states for each of the display endpoints based on the similarity scores.

10. A computer-implemented method for content distribution and verification, comprising:
generating source fingerprints from content streams, wherein each source fingerprint represents distinctive features of content including primary content and custom content; receiving captured content samples from a plurality of sink sampling points positioned at a plurality of display endpoints;
generating sink fingerprints from the captured content samples;
identifying one or more candidate source fingerprints corresponding to each sink fingerprint based on temporal association of the captured content samples;
computing a similarity score between each sink fingerprint and at least one candidate source fingerprint using a similarity function applied to feature representations of the fingerprints;
determining a content delivery state for each display endpoint based on the similarity score and a predetermined threshold, wherein the content delivery state comprises at least one of a match condition or a mismatch condition; and
storing verification results including the determined content delivery state for the plurality of display endpoints.

11. The method of claim 10, wherein computing the similarity score comprises computing the similarity score based on a plurality of temporally adjacent sink fingerprints and corresponding candidate source fingerprints.

12. The method of claim 11, wherein the similarity score is computed by aggregating similarity values across the plurality of temporally adjacent fingerprints using at least one aggregation function.

13. The method of claim 10, further comprising determining the mismatch condition when the similarity score remains below the predetermined threshold for a persistence duration.

14. The method of claim 10, wherein the predetermined threshold comprises a plurality of thresholds including at least a first threshold corresponding to a match condition and a second threshold corresponding to a candidate match condition.

15. The method of claim 10, further comprising generating a routing update instruction responsive to the mismatch condition.

16. The method of claim 15, wherein generating the routing update instruction comprises comparing intended content associated with a display endpoint with observed content identified from the candidate source fingerprint.

17. The method of claim 10, further comprising simultaneously routing different primary content and corresponding different custom content to different display endpoints, and determining respective content delivery states for each of the display endpoints based on the similarity scores.

18. The method of claim 10, further comprising continuously monitoring content delivery across the plurality of display endpoints by repeatedly generating sink fingerprints and determining the content delivery state over time.
